(19) United States
(12) Patent Application Publication
(10) Pub. No.: US 2010/0304055 A1
(43) Pub. Date: Dec. 2, 2010

(54) Automobile decorative item

(75) Inventor: Jui Bin Hwan, Taipei County (TW)

Correspondence Address: BACON & THOMAS, PLLC, 625 SLATERS LANE, FOURTH FLOOR, ALEXANDRIA, VA, 22314-1176, US

(73) Assignee: Great Performance Industries Co., Ltd., Taipei County (TW)

(21) Appl. No.: 12/453,951

(22) Filed: May 28, 2009

(51) Int. Cl. B60R 13/00

(52) U.S. Cl. 428/31

(57) ABSTRACT

The present invention discloses an automobile decorative item fixed onto an automobile rod such as an end of an automobile shift stick or an automobile headrest rod to show a unique decorating effect. The automobile decorative item includes a decorative tube with lines or patterns, a fixing device covered onto both ends of the decorative tube and fixed to the automobile rod, and a stylish tube sheathed onto the external periphery of the decorative tube and having a hollow portion. The fixing device can be installed or removed by users easily, and the decorative tube and the stylish tube can be changed to show the stylish appearance of the automobile decorative item.

### BACKGROUND OF THE INVENTION

1. Field of the Invention

The present invention relates to a structural technology of decorative items, in particular to an automobile decorative item fixed to a rod of a motor vehicle to achieve a unique decorative effect.

2. Description of the Related Art

As to many people, a motor vehicle also expresses a person's individual characteristics and styles, in addition to its transportation function. For example, some car owners place or hang decorative items in their cars, or even change the interior design or leather seats of their cars to express personal styles by the special lines of leather.

To express the individual style of a motor vehicle more significantly, some car owners change a stick shift knob of the motor vehicle to a knob with special features and styles. In addition, there many other metal rods (such as headrest rods disposed at the bottom of a head rest) having the same original color of the motor vehicle and exposed from the motor vehicle, and thus a better decorating effect can be achieved by covering or decorating such metal rods.

In view of the aforementioned issues, the inventor of the present invention conducted extensive researches and experiments to find a way of decorating the automobile rods such as the shift sticks and the headrest rods, and developed an automobile decorative item provided for users to install the decorative item onto the automobile rods on their own.

### SUMMARY OF THE INVENTION

Therefore, it is a primary objective of the present invention to provide an automobile decorative item that can be installed easily to change and give a stylish appearance.

To achieve the foregoing objectives, the present invention provides an automobile decorative item comprising a decorative tube and a fixing device.

The decorative tube includes a tubular structure and a decorative lined skin covered onto a surface of the tubular structure, and the fixing device is covered onto both ends of the decorative tube and fixed at the automobile rod. For example, the decorative tube is fixed on a shift stick or a headrest rod. If a user wants to change decorative lines or patterns shown by the automobile decorative item, the user simply replaces the decorative tube to change the overall appearance of the automobile decorative item. Further, the tubular structure and the fixing device can be modularized when the automobile decorative item is produced, such that the decorative lines and patterns of the skin of the tubular structure can be changed to give an automobile decorative item with a different style.

A fixing device of the present invention is provided for fixing the automobile decorative item onto an end of the automobile rod, and the fixing device includes a top cover component fixed to a distal opening at the top of the decorative tube, a bottom cover component fixed to a distal opening at the bottom of the decorative tube for passing and positioning the automobile rod. The top cover component includes a top cover covered onto the distal opening at the top of the decorative tube and a screw rod connected between the top cover and the bottom cover component. The bottom cover component includes a bottom cover covered onto the distal opening at the bottom of the decorative tube and provided for connecting a screw rod, a fixing base disposed at the bottom of the bottom cover and having a fixing slot for inserting and fixing an end of the automobile rod, and a base cap installed at a lower external periphery of the fixing base.

After an end of the automobile rod is inserted into the fixing slot, a plurality of screws passing through the fixing base can be used for radially compressing or locking the end of the automobile rod to achieve the fixing effect, and then the base cap is covered onto the lower external periphery of the fixing base to make the automobile decorative item fixed on the automobile rod more aesthetical. This kind of fixing devices can fix the automobile decorative item to the end of the automobile rod effectively. For example, the automobile decorative item can be fixed to the end of the shift stick and provided for user to grip the automobile decorative item for the operation of shifting gears.

The present invention provides another kind of fixing devices for passing and installing an automobile rod, wherein the whole automobile decorative item can be sheathed onto the automobile rod to show a unique decorative effect. The fixing device includes a top cover component fixed to a distal opening at the top of the decorative tube and provided for passing the automobile rod, and a bottom cover component fixed to a distal opening at the bottom of the decorative tube and provided for passing through the automobile rod. The top cover component includes a top cover covered onto the distal opening at the top of the decorative tube and having an upper through hole, and an upper fixing plate embedded into an internal wall of the top cover and having an upper crack hole corresponding to the upper through hole. The bottom cover component includes a bottom cover covered onto the distal opening at the bottom of the decorative tube and having a lower through hole, and a lower fixing plate embedded into an internal wall of the bottom cover and having a lower crack hole corresponding to the lower through hole.

After the automobile rod is passed through the upper through hole, the lower through hole, the upper crack hole and the lower crack hole, the whole automobile decorative item can be sheathed onto the automobile rod to achieve the effects of covering and decorating the automobile rod, and the upper crack hole and the lower crack hole can be used for clamping the upper fixing plate and the lower fixing plate of different diameters onto the automobile rod. Such arrangement not only achieves the positioning effect, but also prevents a noise caused by vibrations formed by a collision of the automobile rod with the upper through hole and the lower through hole.

In practices, the decorative tube further includes at least one decorative member embedded onto the skin, a plurality of embedding pillars installed at a back side of the decorative member, and a plurality of embedding holes disposed on the tubular structure and corresponding to the embedding pillars, such that the decorative member can have a better positioning effect, and the decorative member can be installed to show the stylish features of the decorative tube.

In addition, the present invention further comprises a stylish tube with a hollow portion disposed on the external periphery of the decorative tube, such that the decorative lines of the stylish tube can be shown from the hollow portion, and a plurality of transparent elements and reflecting elements are embedded onto the stylish tube to make the automobile decorative item more aesthetical.

Compared with the prior art, the present invention has the advantages of decorating the automobile rod, showing the stylish appearance of the automobile decorative item by changing the decorative tube and the stylish tube, and facilitating the modular manufactures, so that users can install or remove the automobile decorative item on their own.

The technical characteristics of the present invention will become apparent from the following detailed description taken with the accompanying drawings.

### BRIEF DESCRIPTION OF THE DRAWINGS

FIG. 1 is a perspective view of a first preferred embodiment of the present invention;

FIG. 2 is an exploded view of a first preferred embodiment of the present invention;

FIG. 3 is a cross-sectional view of a first preferred embodiment of the present invention;

FIG. 4 is a perspective view of a second preferred embodiment of the present invention;

FIG. 5 is an exploded view of a second preferred embodiment of the present invention;

FIG. 6 is a cross-sectional view of a second preferred embodiment of the present invention;

FIG. 7 is a schematic view of different appearances of a stylish tube in accordance with a second preferred embodiment of the present invention;

FIG. 8 is a perspective view of a third preferred embodiment of the present invention;

FIG. 9 is an exploded view of a third preferred embodiment of the present invention;

FIG. 10 is a cross-sectional view of a third preferred embodiment of the present invention;

FIG. 11 is a perspective view of a fourth preferred embodiment of the present invention;

FIG. 12 is an exploded view of a fourth preferred embodiment of the present invention; and

FIG. 13 is a cross-sectional view of a fourth preferred embodiment of the present invention.

### DETAILED DESCRIPTION OF THE PREFERRED EMBODIMENTS

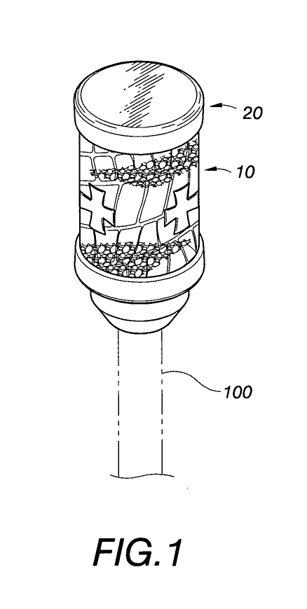

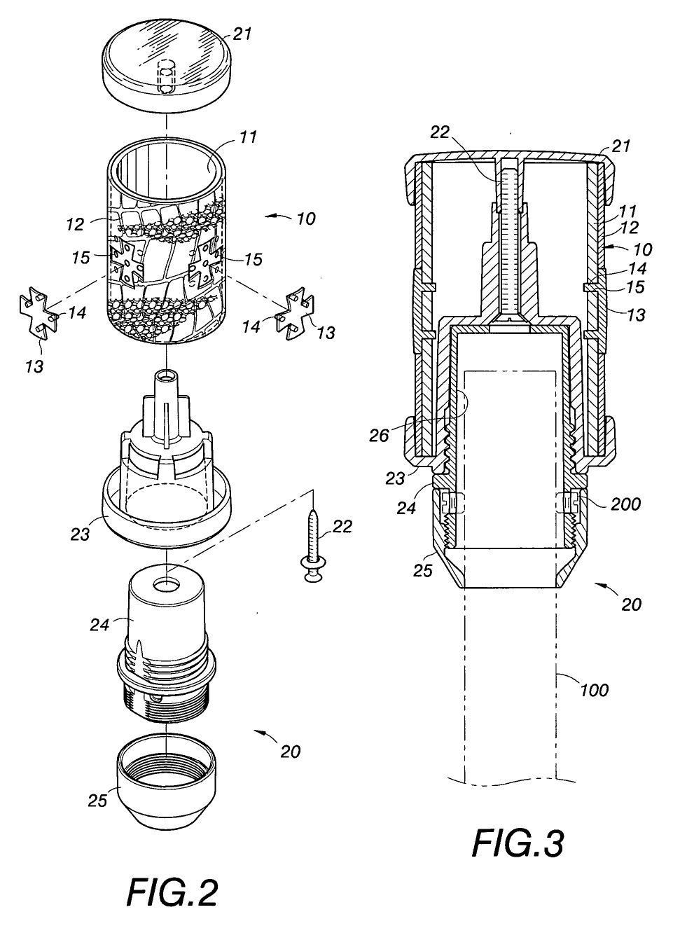

With reference to FIGS. 1 and 2 for a perspective view and an exploded view of a first preferred embodiment of the present invention respectively, an automobile decorative item comprises a decorative tube 10 and a fixing device 20.

The decorative tube 10 includes a tubular structure 11, a decorative lined skin 12 covered onto a surface of the tubular structure 11, a decorative member 13 embedded onto the skin 12, a plurality of embedding pillars 14 installed at a back side of the decorative member 13, and a plurality of embedding holes 15 disposed on the tubular structure 11 and corresponding to the embedding pillar 14 for providing a better positioning effect to the decorative member 13.

The fixing device 20 includes a top cover 21, a screw rod 22, a bottom cover 23, a fixing base 24 and a base cap 25, wherein the top cover 21 and the screw rod 22 constitute a top cover component fixed to a distal opening at the top of the decorative tube 10; and the bottom cover 23, the fixing base 24 and the base cap 25 constitute a bottom cover component fixed to a distal opening at the bottom of the decorative tube 10 for passing and positioning the automobile rod 100.

With reference to FIGS. 2 and 3, FIG. 3 shows a cross-sectional view of a first preferred embodiment of the present invention, wherein the top cover 21 is covered onto the distal opening at the top of the decorative tube 10, and the bottom cover 23 is covered onto the distal opening at the bottom of the decorative tube 10, and the screw rod 22 is connected between the top cover 21 and the bottom cover 23, and the fixing base 24 is installed to the bottom of the bottom cover 23 and having a fixing slot 26 for inserting and positioning an end of the automobile rod 100, and the base cap 25 is installed at a lower external periphery of the fixing base 24.

After the end of the automobile rod 100 is inserted into the fixing slot 26, a plurality of screws 200 passing through the fixing base 24 can be used for radially compressing or locking the end of the automobile rod 100 to achieve the fixing effect, and then the base cap 25 is provided for covering the lower external periphery of the fixing base 24 to make the automobile decorative item fixed onto the automobile rod 100 more aesthetical. In this preferred embodiment, the decorative tube 10 can be fixed onto the end of the automobile rod 100. For example, the decorative tube 10 is fixed onto a shift stick, and the decorative lines on the surface of the decorative tube 10 can provide an appropriate slippery-resisting effect for users to grip.

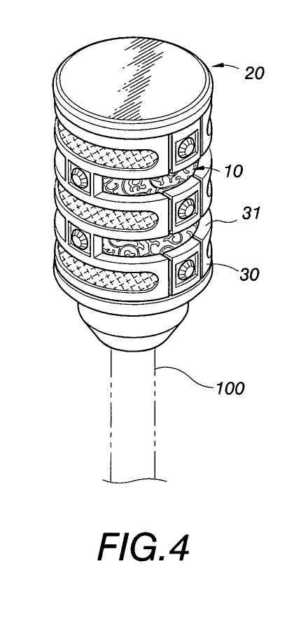

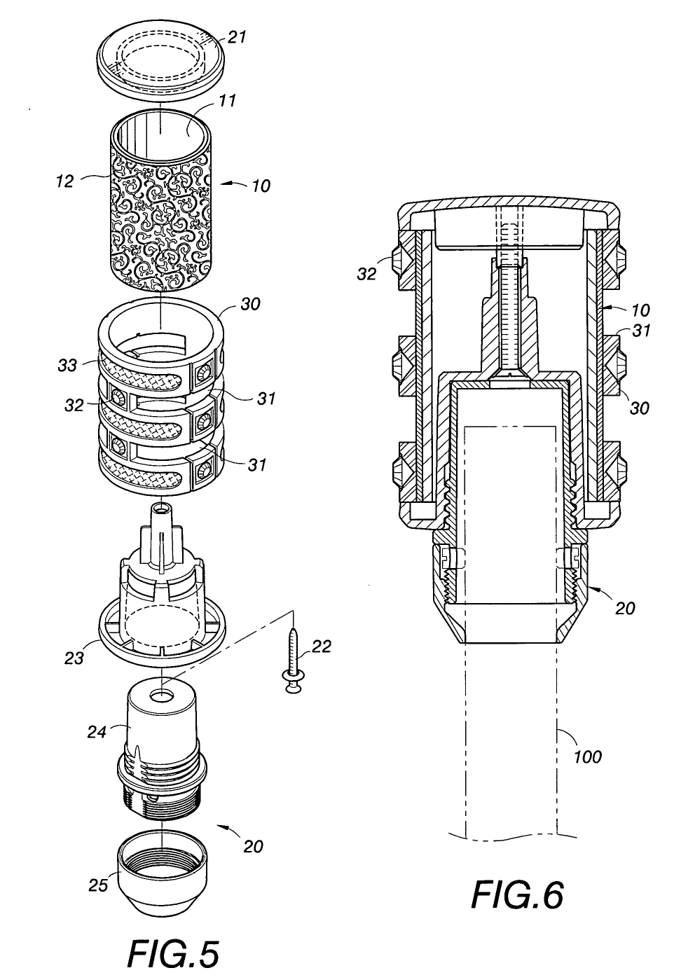

With reference to FIGS. 4 and 5 for a perspective view and an exploded view of a second preferred embodiment of the present invention respectively, the difference of the second preferred embodiment from the first preferred embodiment resides on that the automobile decorative item of the second preferred embodiment further comprises a stylish tube 30, and a plurality of hollow portions 31 disposed on a side of the stylish tube 30, in addition to a decorative tube 10 and a fixing device 20.

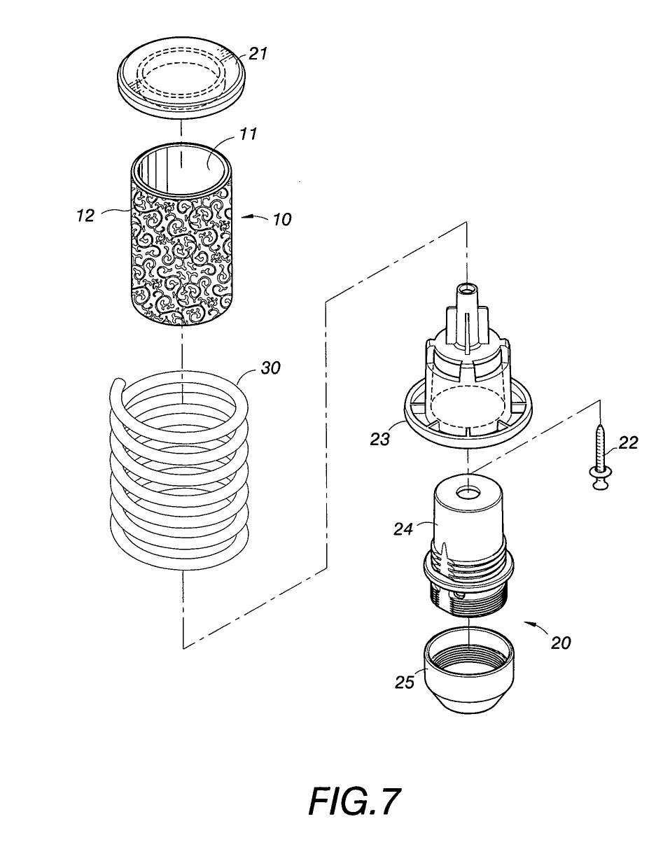

With reference to FIGS. 5 and 6, FIG. 6 shows a cross-sectional view of a second preferred embodiment of the present invention, wherein the decorative tube 10 and the fixing device 20 are substantially the same as the first preferred embodiment, and the stylish tube 30 is sheathed onto the external periphery of the decorative tube 10, such that the decorative lines of the stylish tube 30 can be shown from the hollow portion 31, and a plurality of transparent elements 32 (such as crystals or rhinestones) and reflecting elements 33 (such as laser stickers) are embedded at appropriate positions of the stylish tube 30 to provide a more brilliant stylish appearance of the stylish tube 30. Alternatively, the stylish tube 30 can be manufactured into a form wrapped with a spring as shown in FIG. 7 to give an overall metal-like mechanical appearance.

With the decorative tube 10 and the stylish tube 30, the automobile decorative item not only shows a multi-layer visual feeling, but also increases the slippery-resisting effect for the surface of the automobile decorative item. In this preferred embodiment, the decorative tube 10 and the stylish tube 30 are positioned at the end of the automobile rod 100 such as a shift stick, and the stylish appearance of the stylish tube 30 provides an appropriate slippery-resisting effect for users to grip.

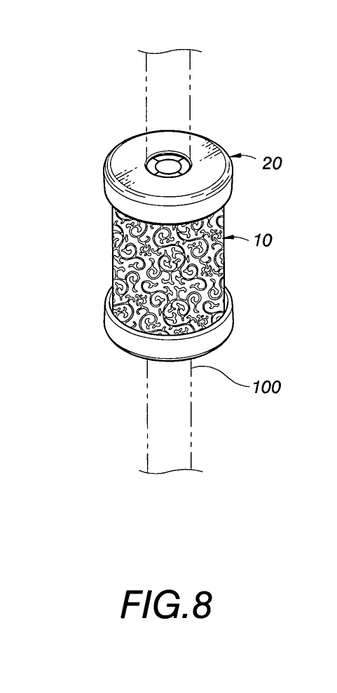

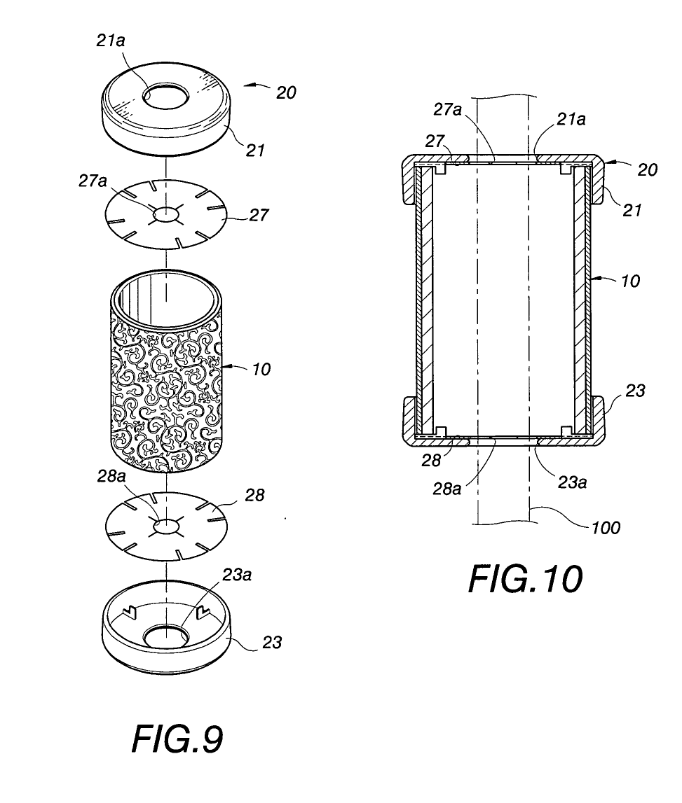

With reference to FIGS. 8 and 9 for a perspective view and an exploded view of a third preferred embodiment of the present invention respectively, an automobile decorative item comprises a decorative tube 10 and a fixing device 20, and the structure of the decorative tube 10 disclosed in this preferred embodiment is substantially the same as the first preferred embodiment, except that the fixing device 20 of this preferred embodiment is provided for passing and installing the automobile rod 100, such that the whole automobile decorative item can be sheathed onto the automobile rod 100 to show a unique decorative effect. This embodiment is particularly suitable for an application of sheathing the automobile decorative item onto a headrest rod.

With reference to FIGS. 9 and 10, FIG. 10 shows a cross-sectional view of a third preferred embodiment of the present invention, wherein the fixing device 20 of the third preferred embodiment comprises a top cover 21, an upper fixing plate 27, a bottom cover 23 and a lower fixing plate 28; and the top cover 21 and the upper fixing plate 27 constitute a top cover component fixed to the distal opening at the top of the decorative tube 10 for passing through the automobile rod 100, and the bottom cover 23 and the lower fixing plate 28 constitute a bottom cover component fixed to the distal opening at the bottom of the decorative tube 10 for passing through the automobile rod 100.

The top cover 21 is covered onto the distal opening at the top of the decorative tube 10 and has an upper through hole 21a disposed at the center of the top cover 21, and an upper fixing plate 27 is embedded into an internal wall of the top cover 21 and has an upper crack hole 27a corresponding to the upper through hole 21a, and the bottom cover 23 is covered onto the distal opening at the bottom of the decorative tube 10 and has a lower through hole 23a disposed at the center of the bottom cover 23, and a lower fixing plate 28 is embedded into an internal wall of bottom cover 23 and has a lower crack hole 28a corresponding to the lower through hole 23a.

After the automobile rod is passed through the upper through hole 21a, the lower through hole 23a, the upper crack hole 27a and the lower crack hole 28a, the whole automobile decorative item can be sheathed onto the automobile rod 100 to achieve the effects of covering and decorating the automobile rod 100, and the upper crack hole 27a and the lower crack hole 28a can be used for clamping the upper fixing plate 27 and the lower fixing plate 28 of different diameters onto the automobile rod 100. Such arrangement not only provides a positioning effect, but also prevents a noise caused by vibrations produced from a collision of the automobile rod with the upper through hole and the lower through hole.

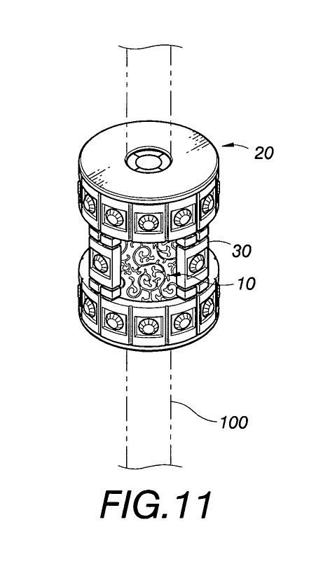

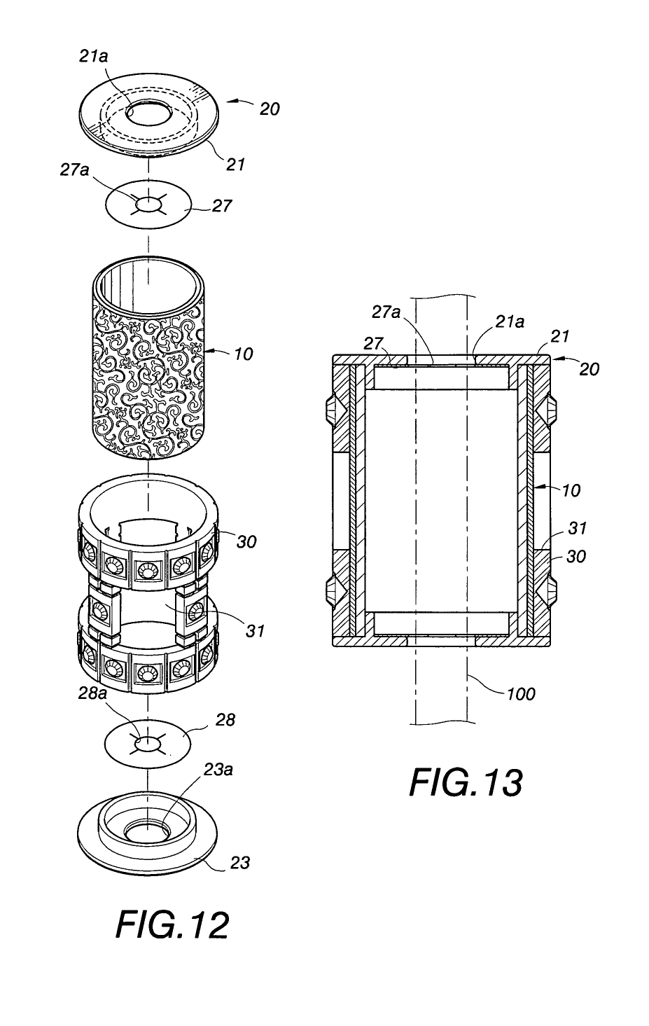

With reference to FIGS. 11 and 12 for a perspective view and an exploded view of a third preferred embodiment of the present invention respectively, the difference of the fourth preferred embodiment from the third preferred embodiment resides on that the automobile decorative item of the fourth preferred embodiment further comprises a stylish tube 30 having a plurality of hollow portions 31 disposed on a side of the stylish tube 30, in addition to a decorative tube 10 and a fixing device 20.

With reference to FIGS. 12 and 13, FIG. 13 shows a cross-sectional view of a fourth preferred embodiment of the present invention, wherein the stylish tube 30 is sheathed onto the external periphery of the decorative tube 10, such that the decorative lines of the stylish tube 30 can be shown from the hollow portion 31. With the decorative tube 10 and the stylish tube 30, the automobile decorative item can show a multi-layer visual feeling.

In summation of the description above, the fixing device 20 as shown in each preferred embodiments of the present invention can be installed or removed by users easily, so that the decorative tube 10 and the stylish tube 30 can be replaced conveniently to change the appearance of the automobile decorative item.

While the invention has been described by means of specific embodiments, numerous modifications and variations could be made thereto by those skilled in the art without departing from the scope and spirit of the invention set forth in the claims.

What is claimed is:

1. An automobile decorative item, comprising a decorative tube and a fixing device covered onto both ends of the decorative tube and fixed to an automobile rod; and the decorative tube including a tubular structure and a decorative lined skin covered onto a surface of the tubular structure; and the fixing device including a top cover component fixed to a distal opening at the top of the decorative tube, and a bottom cover component fixed to a distal opening at the bottom of the decorative tube for passing and positioning the automobile rod.

2. The automobile decorative item of claim 1, wherein the top cover component includes a top cover covered onto the distal opening at the top of the decorative tube and a screw rod connected between the top cover and the bottom cover component; and the bottom cover component includes a bottom cover covered onto the distal opening at the bottom of the decorative tube for connecting the screw rod, a fixing base disposed at the bottom of the bottom cover and having a fixing slot for inserting and fixing an end of the automobile rod, and a base cap installed at a lower external periphery of the fixing base.

3. The automobile decorative item of claim 1, wherein the decorative tube further comprises at least one decorative member embedded into the skin, and the decorative member includes a plurality of embedding pillars disposed at a rear side of the decorative member, and the tubular structure includes a plurality of embedding holes corresponding to the embedding pillars.

4. The automobile decorative item of claim 1, further comprising a stylish tube sheathed onto the external periphery of the decorative tube and having a hollow portion.

5. The automobile decorative item of claim 4, wherein the stylish tube includes a transparent element embedded thereon.

6. The automobile decorative item of claim 4, wherein the stylish tube includes a reflecting element embedded thereon.

7. An automobile decorative item, comprising a decorative tube and a fixing device covered onto both ends of the decorative tube and fixed to an automobile rod; and the decorative tube including a tubular structure and a decorative lined skin covered onto a surface of the tubular structure; and the fixing device including a top cover component fixed to a distal opening at the top of the decorative tube for passing the automobile rod, and a bottom cover component fixed to a distal opening at the bottom of the decorative tube for passing the automobile rod.

8. The automobile decorative item of claim 7, wherein the top cover component includes a top cover covered onto the distal opening at the top of the decorative tube and having an upper through hole, and an upper fixing plate embedded into an internal wall of the top cover and having an upper crack hole corresponding to the upper through hole; and the bottom cover component includes a bottom cover covered onto the distal opening at the bottom of the decorative tube and having a lower through hole, and a lower fixing plate embedded into an internal wall of the bottom cover and having a lower crack hole corresponding to the lower through hole.

9. The automobile decorative item of claim 7, wherein the decorative tube further comprises at least one decorative member embedded into the skin, and the decorative member includes a plurality of embedding pillars disposed at a rear side of the decorative member, and the tubular structure includes a plurality of embedding holes corresponding to the embedding pillars.

10. The automobile decorative item of claim 7, further comprising a stylish tube sheathed onto the external periphery of the decorative tube and having a hollow portion.

11. The automobile decorative item of claim 10, wherein the stylish tube includes a transparent element embedded thereon.

12. The automobile decorative item of claim 10, wherein the stylish tube includes a reflecting element embedded thereon.
